(19) United States
(12) Patent Application Publication
(10) Pub. No.: US 2025/0029776 A1
(43) Pub. Date: Jan. 23, 2025

(54) INDUCTOR

(71) Applicant: Panasonic Intellectual Property Management Co., Ltd., Osaka (JP)

(72) Inventors: KIYOSHI TAKAGI, Hyogo (JP); YUSUKE NAKAMURA, Hyogo (JP); MASAHIRO ENOMOTO, Osaka (JP); HIROSHI TOMITA, Nara (JP); SATORU SHIMOMURA, Hyogo (JP)

(21) Appl. No.: 18/710,209

(22) PCT Filed: Sep. 21, 2022
(86) PCT No.: PCT/JP2022/035256

§ 371 Date: May 15, 2024

(30) Foreign Application Priority Data
Nov. 29, 2021 (JP) 2021-192756

(51) Int. Cl. H01F 27/29; H01F 27/24

(52) U.S. Cl. CPC H01F 27/29; H01F 27/24

(57) ABSTRACT

An object of the present disclosure is to achieve a small-sized inductor capable of handling a high current, and having a high coupling coefficient. Inductor includes magnetic core and coil element embedded in magnetic core. Coil element includes at least four flat coils, and first coil element, second coil element, third coil element, and fourth coil element are provided in an overlapping manner. Ends of each coil element protrude from bottom surface, and are bent along bottom surface, to form external electrode. Ends of first coil element and ends of third coil element are bent toward first side surface. Ends of second coil element and ends of fourth coil element are bent toward second side surface.

### TECHNICAL FIELD

The present disclosure relates to an inductor used in a power supply circuit or the like.

### BACKGROUND ART

In recent years, as low-voltage large-scale integrated circuits such as central processing units (CPUs) have come to be developed, not only the current required in elements reaches several tens of amperes, but also small and low-profile power supply circuits have come to be required. To meet such a high-current requirement, a multiphase power supply system has been mainly used. As a power supply scheme supported by such multiphase power supply systems, a coupling method has been put in use. Inductors used for such a coupling method are driven by an inductor including a plurality of coils coupled at a coupling coefficient of approximately 0.6.

As an example of the prior art document information, PTL 1 is known.

### CITATION LIST

### Patent Literature

PTL 1: Unexamined Japanese Patent Publication No. 2008-235773

### SUMMARY OF THE INVENTION

However, such a conventional coupling method has a limitation when even higher currents are desirable. To overcome such a limitation, a technology referred to as a multiphase voltage regulator is currently under development. In this technology, coupling between the plurality of coils need to be enhanced significantly, and conventional inductors used in coupling cannot achieve characteristics sufficient to serve this purpose. In order to increase the coupling coefficient, it is necessary to increase the area by which the plurality of coils face each other. This increase in the area makes it difficult to use electrode arrangements having been used in the conventional coupled inductors.

An object of the present disclosure is to provide a small-sized inductor capable of handling a high current, and having a high coupling coefficient.

In order to solve the above problem, an inductor according to the present disclosure includes: a magnetic core having a cuboid shape, formed by pressure-molding a mixture of magnetic material powder and a binder; and a coil element embedded in the magnetic core. The magnetic core has a bottom surface, a top surface facing the bottom surface, a first side surface connected to the bottom surface and the top surface, and a second side surface facing the first side surface. The coil element includes at least four flat coils that are a first coil element, a second coil element, a third coil element, and a fourth coil element, provided in a manner overlapping with one another sequentially in a direction from the first side surface toward the second side surface. The first coil element, the second coil element, the third coil element, and the fourth coil element are provided in a manner overlapping one another sequentially in a direction from the first side surface toward the second side surface. Each of the first coil element to fourth coil element has ends protruding from the bottom surface, and bent along the bottom surface, forming external electrodes. An external electrode continuous to the first coil element will be referred to as a first external electrode, an external electrode continuous to the second coil element will be referred to as a second external electrode, an external electrode continuous to the third coil element will be referred to as a third external electrode, and an external electrode continuous to the fourth coil element will be referred to as a fourth external electrode. By bending both ends of the first coil element and both ends of the third coil element toward the first side surface, the first external electrode and the third external electrode are formed, respectively. By bending both ends of the second coil element and both ends of the fourth coil element toward the second side surface, the second external electrode and the fourth external electrode are formed, respectively.

With the configuration described above, it is possible to provide a small-sized inductor capable of handling a high current, and having a high coupling coefficient.

### BRIEF DESCRIPTION OF THE DRAWINGS

FIG. 1 is a perspective view of an inductor according to an exemplary embodiment of the present disclosure.

FIG. 2A is a side view of the inductor according to the exemplary embodiment of the present disclosure.

FIG. 2B is a bottom view of the inductor according to the exemplary embodiment of the present disclosure.

FIG. 2C is an end view of the inductor according to the exemplary embodiment of the present disclosure.

FIG. 3 is a transparent top view of the inductor according to the exemplary embodiment of the present disclosure in use, with the inductor mounted on a mounting board.

FIG. 4A is a plan view of a first coil element included in the inductor according to the exemplary embodiment of the present disclosure.

FIG. 4B is a plan view of a second coil element included in the inductor according to the exemplary embodiment of the present disclosure.

FIG. 4C is a plan view of a third coil element included in the inductor according to the exemplary embodiment of the present disclosure.

FIG. 4D is a plan view of a fourth coil element included in the inductor according to the exemplary embodiment of the present disclosure.

FIG. 5 is a bottom side external view of an inductor according to a modification of the exemplary embodiment of the present disclosure.

FIG. 6 is a transparent top view of the inductor according to the modification of the exemplary embodiment of the present disclosure in use, with the inductor mounted on a mounting board.

### DESCRIPTION OF EMBODIMENT

Inductor 10 according to an exemplary embodiment of the present disclosure will be described below with reference to the drawings.

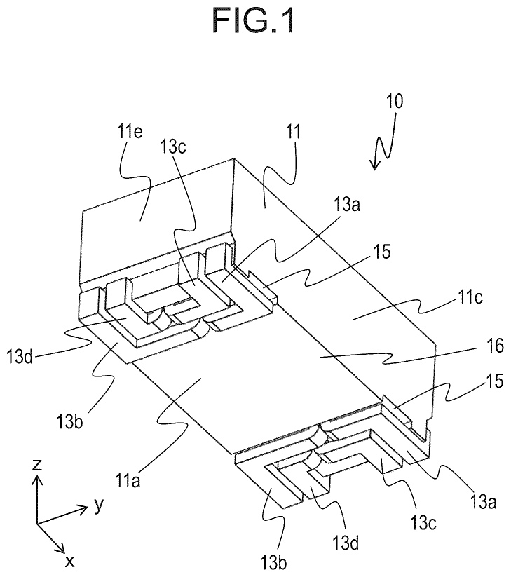

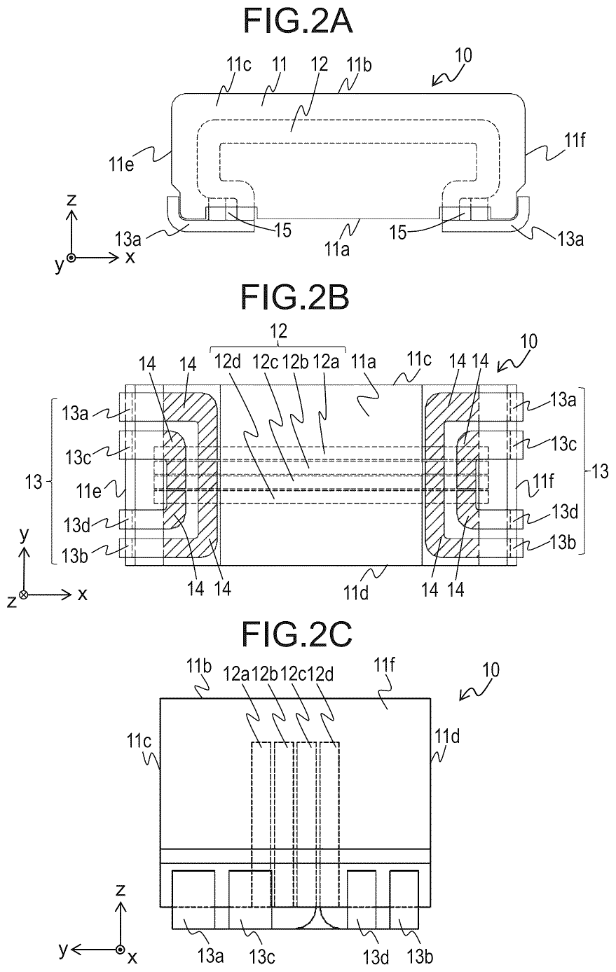

FIG. 1 is a perspective view of inductor 10 as viewed from the side of bottom surface 11a of inductor 10 according to the exemplary embodiment of the present disclosure. FIGS. 2A to 2C are external views of inductor 10 according to the exemplary embodiment of the present disclosure. FIG. 2A is a side view of inductor 10 as viewed from the side of first side surface 11c of inductor 10 according to the exemplary embodiment of the present disclosure. FIG. 2B is a bottom view of inductor 10 as viewed from the side of bottom surface 11a of inductor 10. FIG. 2C is an end view of inductor 10 as viewed from the side of first end face 11f of inductor 10. In FIGS. 2A to 2C, coil elements 12 internal of inductor 10 are indicated with broken lines. In relation to inductor 10 illustrated in FIGS. 1 to 6, an x axis is plotted to a direction from first end face 11e toward second end face 11f as the positive direction; a y axis is plotted to a direction from fourth coil element 12d toward first coil element 12a as a positive direction; and a z axis is plotted to a direction from bottom surface 11a toward top surface 11b of inductor 10 as a positive direction. In other words, an xyz Cartesian coordinate system is plotted in FIGS. 1 to 6.

Inductor 10 according to the exemplary embodiment of the present disclosure includes magnetic core 11 having a cuboid shape, and coil elements 12 embedded in magnetic core 11. Magnetic core 11 is formed by pressure-molding a mixture of magnetic material powder that is powder of Fe—Si—Cr and a silicone binder. The outer shape of magnetic core 11 is a cuboid shape having a width of about 6 mm (in the y-axis direction), a length of about 13 mm (in the x-axis direction), and a height of about 5 mm (in the z-axis direction). Magnetic core 11 has bottom surface 11a where ends of coil elements 12 protrude, top surface 11b facing bottom surface 11a, first side surface 11c connecting bottom surface 11a and top surface 11b, second side surface 11d facing first side surface 11c, first end face 11e connecting first side surface 11c and second side surface 11d, and second end face 11f facing first end face 11e.

Inside magnetic core 11, four coil elements 12 each of which is a flat plate are embedded. In magnetic core 11, first coil element 12a, second coil element 12b, third coil element 12c, and fourth coil element 12d are embedded sequentially in a direction from first side surface 11c toward second side surface 11d, with adjacent pairs of the coil elements having their side surfaces facing each other. Each of coil elements 12 has ends protruding from bottom surface 11a of magnetic core 11, and bent along bottom surface 11a, to form external electrode 13. Each of coil elements 12 is formed by punching a copper plate, and has a thickness of about 0.4 mm and a coil pattern with a width of about 0.8 mm. Insulating layer 16 made of a material such as epoxy resin, phenol resin, or acrylic resin and having a thickness of about 0.03 mm is formed, by pad printing, for example, on the surface of each coil element 12, in the part embedded in magnetic core 11.

An external electrode continuous to first coil element 12a will be referred to as first external electrode 13a, an external electrode continuous to second coil element 12b will be referred to as second external electrode 13b, an external electrode continuous to third coil element 12c will be referred to as third external electrode 13c, and an external electrode continuous to fourth coil element 12d will be referred to as fourth external electrode 13d. Both ends of first coil element 12a and both ends of third coil element 12c are bent toward first side surface 11c, thereby forming first external electrode 13a and third external electrode 13c, respectively. Both ends of second coil element 12b and both ends of fourth coil element 12d are bent toward second side surface 11d, thereby forming second external electrode 13b and fourth external electrode 13d, respectively. Each of first external electrode 13a, second external electrode 13b, third external electrode 13c, and fourth external electrode 13d are then extended toward either first end face 11e or second end face 11f, that is, the directions along the x-axis, and the tips thereof are bent along first end face 11e or second end face 11f. By forming the external electrodes 13 by bending the ends of respective coil elements 12, in a manner protruding from bottom surface 11a as described above, it is possible to achieve inductor 10 requiring a small mounting area.

Bottom surface 11a of magnetic core 11 includes a part where coil elements 12 protrude, and provided with recess 15 at a depth of about 0.4 mm in an area where first side surface 11c and second side surface 11d are connected. By making the ends of coil elements 12 protrude from bottom surface 11a and bent along bottom surface 11a, the bent portions inevitably become bulged, and therefore, the stability of inductor 10 in the process of mounting inductor 10 deteriorates. Therefore, as in the present exemplary embodiment, by making the ends of coil elements 12 protrude from recess 15 provided on bottom surface 11a of magnetic core 11, it is possible to improve the flatness of the mounting surface of the inductor. It is preferable for the depth of recess 15 to be more than or equal to or 80% or less than or equal to 200% of the thickness of external electrodes 13. If the depth of the recess is smaller than 80% of the thickness of the external electrode, the flatness of the mounting surface deteriorates. If the depth exceeds 200%, the volume of the core becomes smaller, and the inductance decreases, unfavorably.

Inductor 10 is configured as described above.

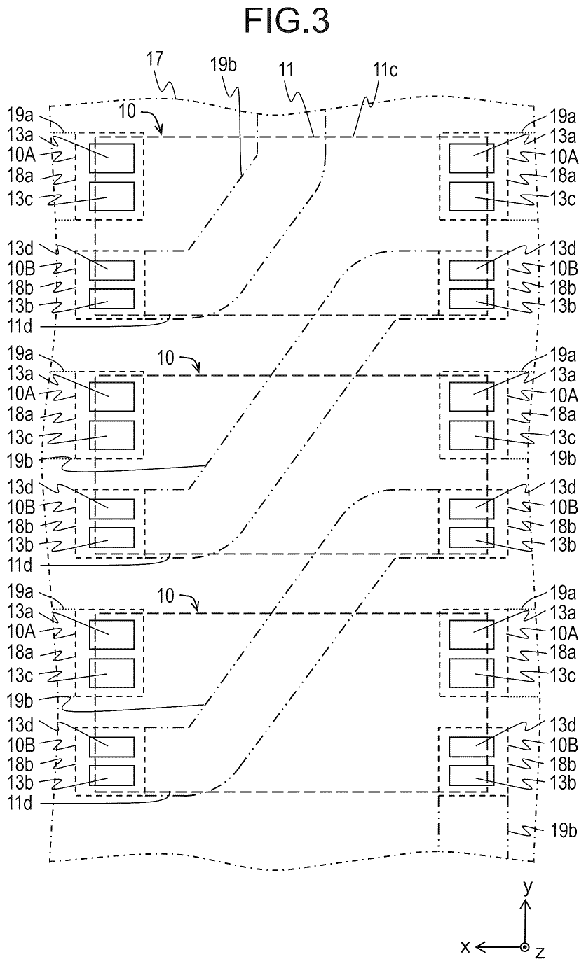

FIG. 3 is a transparent top view of inductor 10 according to the present disclosure in use, with the inductor 10 mounted on mounting board 17. FIG. 3 illustrates an example in which inductor 10 is used in a three-phase multiphase voltage regulator. One inductor 10 is used for each of the phases. FIG. 3 illustrates components around three inductors 10 in the three-phase multiphase voltage regulator. Three inductors 10 are disposed in such a manner that first side surface 11c and second side surface 11d face each other. Pads 18a and pads 18b are provided on mounting board 17, correspondingly to each inductor. In FIG. 3, mounting board 17 is indicated by an alternate long and short dash line, pads 18a and 18b are indicated by broken lines, magnetic cores 11 are indicated by long broken lines, and first external electrode 13a to fourth external electrodes 13d are indicated by solid lines. First external electrode 13a and third external electrode 13c adjacent to each other on mounting board 17 are connected by pad 18a, together forming first inductor 10A, and second external electrode 13b and fourth external electrode 13d adjacent to each other are connected by pad 18b to form second inductor 10B. In this manner, second coil element 12b that is second inductor 10B is disposed between first coil element 12a and third coil element 12c that are first inductors 10A, and third coil element 12c that is first inductor 10A is disposed between second coil element 12b and fourth coil element 12d that are second inductors 10B. Furthermore, because each coil element 12 (any one of first coil element 12a to fourth coil element 12d) overlaps with at least another coil element 12 (at least one of first coil element 12a to fourth coil element 12d) across the entire area where coil elements 12 are embedded in magnetic core 11, it is possible to achieve inductor 10 having a high coupling coefficient between first inductor 10A and second inductor 10B.

In the example of the three-phase multilayer voltage regulator illustrated in FIG. 3, wiring pattern 19a connected to pad 18a and wiring pattern 19b connected to pad 18b are provided on mounting board 17, correspondingly to each inductor 10. In FIG. 3, wiring pattern 19a is indicated by a dotted line, and wiring pattern 19b is indicated by a two-dot chain line. Each of wiring patterns 19a is connected to a regulator circuit of the corresponding phase of the multiphase voltage regulator. Wiring patterns 19b also connect three second inductors 10B in series. Wiring patterns 19b at both ends of the serially connected three second inductors 10B are connected to the ground (GND). Because three second inductors 10B are connected in series, three first inductors 10A are magnetically coupled during the use. In the present exemplary embodiment, because the coupling coefficient between first inductor 10A and second inductor 10B can be increased, the magnetic coupling between three first inductors 10A can be enhanced.

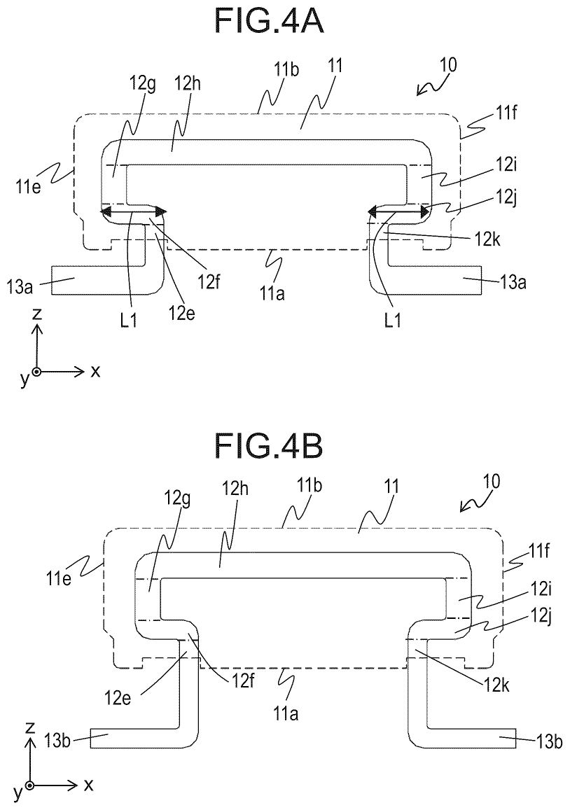

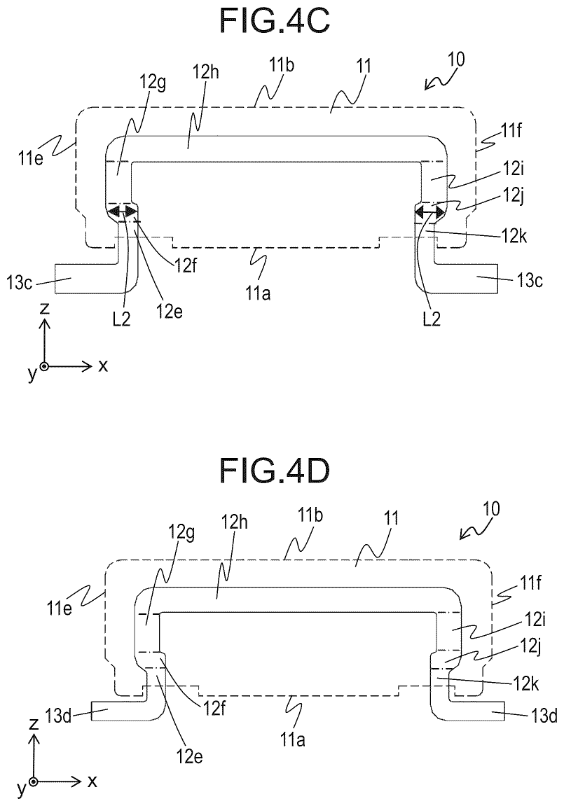

Coil elements 12 will be described in more detail. FIG. 4A is a plan view of first coil element 12a, FIG. 4B is a plan view of second coil element 12b, FIG. 4C is a plan view of third coil element 12c, and FIG. 4D is a plan view of fourth coil element 12d. In each of FIGS. 4A to 4D, the outer shape of magnetic core 11 with first coil element 12a to fourth coil element 12d embedded in magnetic core 11 is indicated by a broken line. After first coil element 12a to fourth coil element 12d are embedded in magnetic core 11, the ends of first coil element 12a to fourth coil element 12d protruding to the outside of the broken line are bent along bottom surface 11a, to form first external electrode 13a to fourth external electrode 13d, respectively. In addition, in FIGS. 4A to 4D, in order to make the areas corresponding to a first portion to a seventh portion more recognizable, boundaries thereof are indicated by alternate long and short dash lines.

Each of first coil element 12a to fourth coil element 12d has following portions (a) to (g) inside magnetic core 11.
(a) First portion 12e extending from bottom surface 11a toward top surface 11b.
(b) Second portion 12f continuous to an end of first portion 12e, the end being on the side of top surface 11b, and extending toward first end face 11e.
(c) Third portion 12g continuous to an end of the second portion 12f, the end being on the side of top surface 11b and on the side of first end face 11e, and extending toward top surface 11b.
(d) Fourth portion 12h continuous to an end of third portion 12g, the end being on the side of top surface 11b, and extending toward second end face 11f.
(e) Fifth portion 12i continuous to an end of fourth portion 12h, the end being on the side of bottom surface 11a and on the side of second end face 11f, and extending toward bottom surface 11a.
(f) Sixth portion 12j continuous to an end of fifth portion 12i, the end being on the side of bottom surface 11a, and extending toward first end face 11e.
(g) Seventh portion 12k continuous to an end of sixth portion 12j, the end being on the side of bottom surface 11a and on the side of first end face 11e, and extending toward bottom surface 11a.

Respective ends of each of first coil element 12a to fourth coil element 12d, on the side of bottom surface 11a, protrude from ends of first portion 12e and seventh portion 12k, respectively, on bottom surface 11a of magnetic core 11. Ends of first coil element 12a to fourth coil element 12d are then bent along bottom surface 11a of magnetic core 11, to form first external electrode 13a to fourth external electrode 13d, respectively.

In first coil element 12a and second coil element 12b, the lengths (L1 in FIG. 4A) of second portion 12f and sixth portion 12j are longer than the lengths (L2 in FIG. 4C) of second portion 12f and sixth portion 12j of third coil element 12c and fourth coil element 12d, by the width of the coil pattern.

First coil element 12a and second coil element 12b overlap each other across the entire paths embedded in magnetic core 11, and third coil element 12c and fourth coil element 12d overlap each other across the entire paths embedded in magnetic core 11. Further, in the third portion 12g to the fifth portion 12i, first coil element 12a, second coil element 12b, third coil element 12c, and fourth coil element 12d all overlap with one another. Therefore, it is possible to achieve a high coupling coefficient between first inductor 10A and second inductor 10B.

In third coil element 12c and fourth coil element 12d, the first, second, sixth, and seventh portions may be omitted, and the third portion and the fifth portion may be extended to the bottom surface. However, the second portion and the sixth portion of the coil elements are preferably disposed in a manner at least partially overlapping each other, because this part can serve to increase the coupling coefficient between the plurality of coils. In FIGS. 4A to 4D, the loop of the coil has a rectangular shape, but the loop may have a rounded Ω shape.

With the configuration described above, an area where the end of second coil element 12b and the end of third coil element 12c face each other near each other is formed on bottom surface 11a. When these facing areas are conductive on the end of second coil element 12b and the end of third coil element 12c, the coil elements can become more easily short-circuited at the time of mounting. Therefore, it is preferable to provide insulating layer 14 on the areas where the end of second coil element 12b and the end of third coil element 12c face each other. Note that, in FIG. 2B, parts where insulating layer 14 is provided is hatched for easy understanding. It is desirable for insulating layer 14 to be formed at the same time as when the insulating layer is formed on the part of coil elements 12 embedded in magnetic core 11. By doing so, the process can be simplified.

### Modification

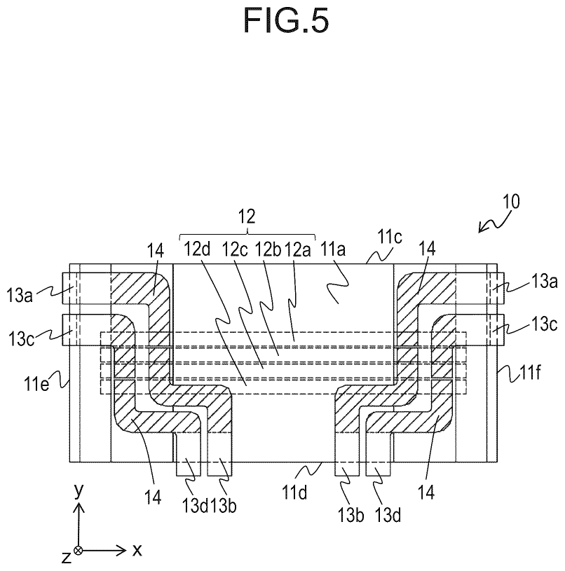

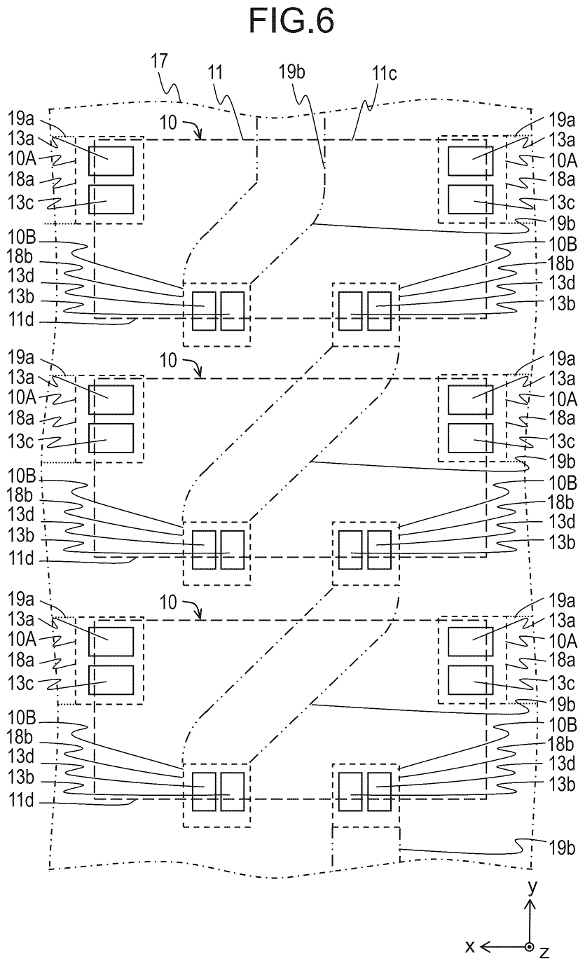

FIG. 5 is a bottom side external view of inductor 10, as viewed from the side of bottom surface 11a of inductor 10 according to a modification of the exemplary embodiment of the present disclosure. FIG. 6 is a transparent top view of inductors 10 according to the modification in use, in a manner mounted on mounting board 17. The usage example illustrated in FIG. 6 depicts an example in which inductors are used in a three-phase multiphase voltage regulator, in the same manner as in the usage example described with reference to FIG. 5. One inductor 10 is used for each of the phases. FIG. 6 illustrate components around three inductors 10 of a three-phase voltage regulator multiphase voltage regulator. Three inductors 10 are disposed in such a manner that first side surface 11c and second side surface 11d face each other. Pads 18a and pads 18b are provided on mounting board 17, correspondingly to each inductor. In FIG. 6, mounting board 17 is indicated by an alternate long and short dash line, pads 18a and wiring pads 18b are indicated by broken lines, magnetic cores 11 are indicated by long broken lines, and first external electrode 13a to fourth external electrodes 13d are indicated by solid lines. In FIG. 6, wiring pattern 19a connected to pad 18a and wiring pattern 19b connected to pad 18b are provided on mounting board 17, correspondingly to each inductor 10. In FIG. 6, wiring patterns 19a are indicated by dotted lines, and wiring patterns 19b are indicated by two-dot chain lines.

In FIGS. 1 and 2A to 2C, external electrodes 13 are extended toward first end face 11e or second end face 11f, but some of external electrodes 13 may be extended toward first side surface 11c or second side surface 11d, as illustrated in FIG. 5. In the example illustrated in FIGS. 5 and 6, second external electrode 13b and fourth external electrode 13d are extended toward second side surface 11d. In this manner, it is possible to improve the degree of freedom of wiring patterns 19a and 19b formed on mounting board 17. In particular, the length of wiring patterns 19b connecting second inductors 10B in series can be reduced, compared with that in example illustrated in FIG. 3, so the DC resistance of wiring pattern 19b can be reduced. As a result, a loss in the multiphase voltage regulator can be reduced.

With the configuration described above, it is possible to achieve an inductor in which each of first inductor 10A and second inductor 10B has an inductance (with first coil element and third coil element combined, and second coil element and fourth coil element combined) of about 120 nH, each of first inductor 10A and the second inductor 10B has a DC resistance of about 0.5 mΩ, and in which the coupling coefficient is about 0.98.

### INDUSTRIAL APPLICABILITY

The inductor according to the present disclosure, it is possible to achieve a small-sized inductor capable of handling a high current, and having a high coupling coefficient, and therefore, is industrially useful.

### REFERENCE MARKS IN THE DRAWINGS

10: inductor
10A: first inductor
10B: second inductor
11: magnetic core
11a: bottom surface
11b: top surface
11c: first side surface
11d: second side surface
11e: first end face
11f: second end face
12: coil element
12a: first coil element
12b: second coil element
12c: third coil element
12d: fourth coil element
12e: first portion
12f: second portion
12g: third portion
12h: fourth portion
12i: fifth portion
12j: sixth portion
12k: seventh portion
13: external electrode
13a: first external electrode
13b: second external electrode
13c: third external electrode
13d: fourth external electrode
14, 16: insulating layer
15: recess
17: mounting board
18a, 18b: pad
19a, 19b: wiring pattern

1. An inductor comprising:
a magnetic core having a cuboid shape, and formed by pressure-molding a mixture of magnetic material powder and a binder; and
a coil element embedded in the magnetic core,
wherein
the magnetic core includes
a bottom surface,
a top surface facing the bottom surface,
a first side surface connected to the bottom surface to the top surface, and
a second side surface facing the first side surface, and
the coil element includes at least four flat coils in which a first coil element, a second coil element, a third coil element, and a fourth coil element are provided in a manner overlapping with one another sequentially in a direction from the first side surface toward the second side surface, and
each of the first coil element, the second coil element, the third coil element, and fourth coil element has ends protruding from the bottom surface, and bent along the bottom surface, forming external electrodes, and
referring to the external electrode continuous to the first coil element as a first external electrode, referring to the external electrode continuous to the second coil element as a second external electrode, referring to the external electrode continuous to the third coil element as a third external electrode, and referring to the external electrode continuous to the fourth coil element as a fourth external electrode, the first external electrode and the third external electrode are formed by bending ends of the first coil element and ends of the third coil element toward the first side surface, and
the second external electrode and the fourth external electrode are formed by bending ends of the second coil element and ends of the fourth coil element toward the second side surface.

2. The inductor according to claim 1, wherein the bottom surface includes an area where an end of the second coil element and an end of the third coil element face each other, the area being provided with an insulating layer.
